(19) United States
(12) Patent Application Publication
(10) Pub. No.: US 2010/0107369 A1
(43) Pub. Date: May 6, 2010

(54) HINGE ASSEMBLY

(75) Inventors: XIAO-BO LI, Shenzhen City (CN); JIN-XIN WANG, Shenzhen City (CN); HAN-ZHENG ZHANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/417,817

(22) Filed: Apr. 3, 2009

(30) Foreign Application Priority Data
Nov. 4, 2008 (CN) 200810305379.1

(51) Int. Cl. E05D 11/06; E05D 5/10

(52) U.S. Cl. 16/374; 16/386

(57) ABSTRACT

A hinge assembly includes a rotatable shaft, a fixed stand and a cam rotatably connected to the rotatable shaft, a rotatable stand and a cam follower non-rotatably connected to the rotatable shaft, and an elastic member to provide an elastic force to drive the cam follower to contact the cam. One of the cam and cam follower forms a positioning protrusion, the other of the cam and cam follower defines a positioning groove to engage with the positioning protrusion. The positioning groove has a side wall including a first slanted surface and a second slanted surface connected to each other, the second slanted surface is adjacent to a bottom surface of the positioning groove. A gradient of the first slanted surface relative to the bottom surface of the positioning groove is smaller than that of the second slanted surface relative to the bottom surface of the positioning groove.

### CROSS REFERENCE STATEMENT

This application is related to co-pending U.S. patent applications, which are applications Ser. Nos. 12/261225, 12/261230, and both entitled “HINGE ASSEMBLY”. In the co-pending applications, the inventors are Jin-Xin Wang, Xiao-Bo Li and Lian-Cheng Huang. The co-pending applications have the same assignee as the present application.

### BACKGROUND

1. Technical Field

The present disclosure relates generally to hinge assemblies and, more particularly, to a hinge assembly used in an electronic device.

2. Description of Related Art

An electronic device such as a mobile phone, a notebook computer, or a personal digital assistant, generally has a main body and a display cover pivotally mounted on the main body via a hinge assembly.

A typical hinge assembly includes a shaft, a cam, a cam follower and an elastic member. The cam defines a recess in a side surface, and forms a protrusion on the side surface adjoining the recess via a slanted surface. The cam follower forms a protrusion corresponding to the recess of the cam, and defines a recess corresponding to the protrusion of the cam. The cam is non-rotatably connected to the shaft. The cam follower is rotatably connected to the shaft. The elastic member is sleeved on the shaft to provide an elastic force to drive the cam follower to contact with the cam.

The typical hinge assembly may be retained at a predetermined position when the cam is engaged with the cam follower. When rotating the typical hinge assembly to close, the protrusion of the cam follower contacts the slanted surface of the cam, and the elastic force generated by the elastic member drives the protrusion of the cam follower to slide along the slanted surface and engage in the recess of the cam. Thus, the typical hinge assembly can be automatically closed after manually rotating to a certain position.

However, if the slanted surface of the cam is too steep, the protrusion of the cam follower engages in the recess of the cam too quickly. As a result, the typical hinge assembly will close suddenly, thus introducing a shock or impact to a display cover of an electronic device. If the slanted surface of the cam is too gentle, the typical hinge assembly will close slowly, or be incapable of completely closing. Moreover, the protrusion of the cam follower may easily detach from the recess of the cam. As a result, the display cover may not be stably closed on a main body of the electronic device.

What is needed, therefore, is a new hinge assembly that overcomes the above mentioned disadvantages.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is an exploded, isometric view of a first embodiment of a hinge assembly, the hinge assembly including a cam and a cam follower.

FIG. 2 is an isometric view of the cam follower of the hinge assembly in FIG. 1.

FIG. 3 is similar to FIG. 1, but viewed from another aspect.

FIG. 4 is an assembled, isometric view of the hinge assembly in FIG. 1.

FIG. 5 is a plan view showing the cam engaging with the cam follower in a first position.

FIG. 6 is a plan view showing the cam engaging with the cam follower in a second position.

FIG. 7 is a plan view of a second embodiment of a hinge assembly, showing a cam engaging with a cam follower.

### DETAILED DESCRIPTION

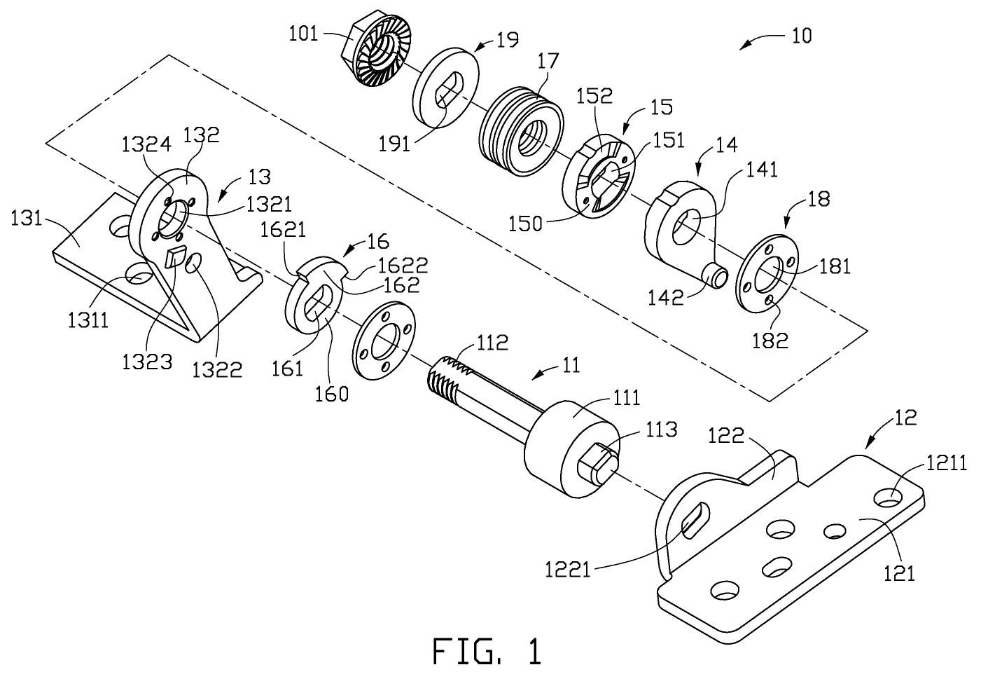

Referring to FIG. 1, a first embodiment of a hinge assembly 10 includes a rotatable shaft 11, a rotatable stand 12, a fixed stand 13, a cam 14, a cam follower 15, a restricting member 16, an elastic member 17, two friction members 18, a washer 19 sleeved on the rotatable shaft 11, and a fastening member 101 latched on an end of the rotatable shaft 11.

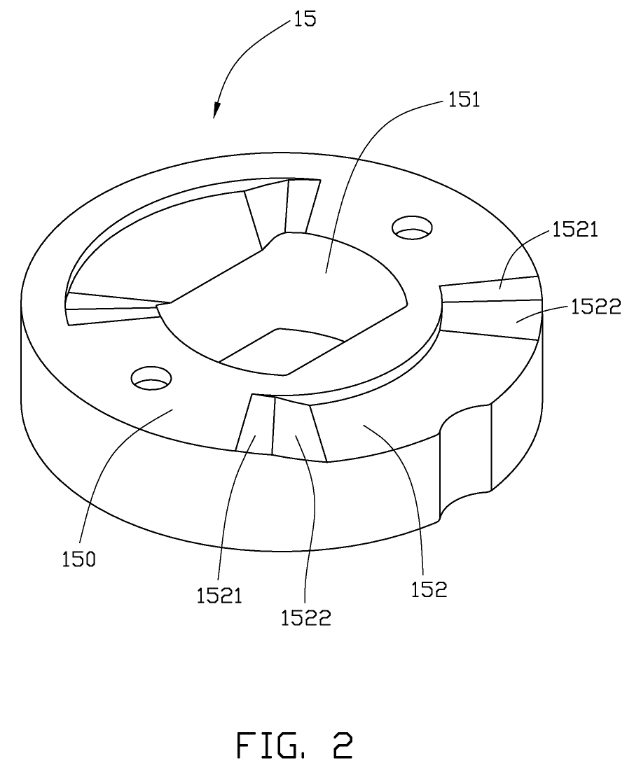

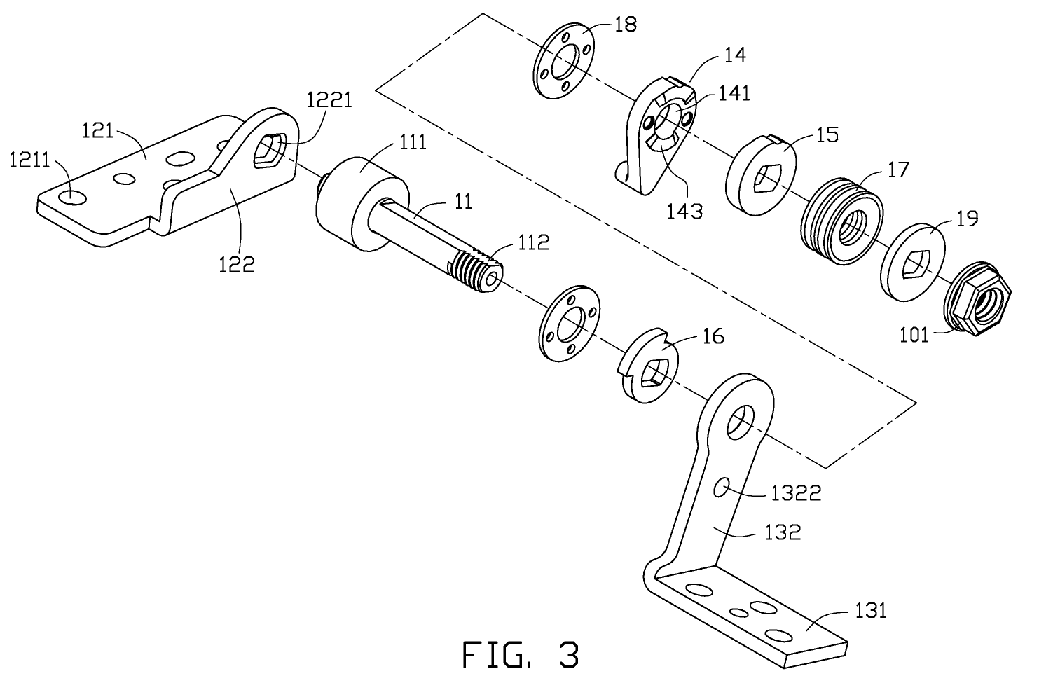

Referring to FIGS. 2 and 3, a cross-section of the rotatable shaft 11 perpendicular to a rotating axis of the rotatable shaft 11 is double-D shaped. A flange 111 is formed on a first end of the rotatable shaft 11, and a threaded portion 112 may be formed on a second end of the rotatable shaft 11. A shaft head 113 extends from the flange 111 along an extending direction of the rotatable shaft 11.

The rotatable stand 12 includes a flat plate 121. The flat plate 121 defines a plurality of fixing holes 1211. A positioning piece 122 extends substantially perpendicularly from a side of the flat plate 121. The positioning piece 122 defines a non-circular pivot hole 1221 corresponding to the shape of the shaft head 113 of the rotatable shaft 11.

The fixed stand 13 includes a fixing plate 131 and a supporting plate 132 extending substantially perpendicularly from a side of the fixing plate 131. The fixing plate 131 defines a plurality of fixing holes 1311. The supporting plate 132 defines a circular pivot hole 1321 in an end away from the fixing plate 131, and an assembling hole 1322 in a middle portion. The supporting plate 332 also forms a limiting protrusion 1323, and defines a plurality of lubricant grooves 1324 adjacent to the pivot hole 1321.

The cam 14 may be substantially fan-shaped, and defines a circular cam hole 141 in a center portion. A fixing pole 142 extends from an end of the cam 14. The cam 14 also forms two positioning protrusions 143 in a side surface. Two side walls of each positioning protrusion 143 are slanted surfaces.

The cam follower 15 may be substantially cylindrical. A center of the cam follower 15 defines a non-circular through hole 151 corresponding to the shape of the cross-section of the rotatable shaft 11. The cam follower 15 defines two positioning grooves 152 in a side surface 150 corresponding to the positioning protrusions 143 of the cam 14. Each positioning groove 152 has two side walls, each side wall includes a first slanted surface 1521 and a second slanted surface 1522 connected to each other. The first slanted surface 1521 is adjacent to the side surface 150. The second slanted surface 1522 is adjacent to a bottom surface of the positioning groove 152. A gradient of the first slanted surface 1521 relative to the bottom surface of the positioning groove 152 is smaller than that of the second slanted surface 1522 relative to the bottom surface of the positioning groove 152.

In alternative embodiments, the positioning grooves 152 may be defined in the cam 14, and the positioning protrusions 143 may be formed on the cam follower 15. In addition, the number of the positioning protrusions 143 and the corresponding number of the positioning grooves 152 may be any desired number, such as one, three, four, five, or more.

The restricting member 16 includes a substantially circular main portion 160. A center of the main portion 160 defines a non-circular through hole 161 corresponding to the shape of the cross-section of the rotatable shaft 11. A restricting portion 162 is formed at an edge of the main portion 160. In the illustrated embodiment, the restricting portion 162 is an arched protrusion extending radially from an edge of the main portion 160. The restricting portion 162 forms a first limiting surface 1621 and a second limiting surface 1622 on opposite ends.

In the illustrated embodiment, the elastic member 17 is a plurality of spring washers. The elastic member 17 may be other elastic components, such as a helical spring.

The friction member 18 defines a circular through hole 181 in a center portion, and defines a plurality of lubricant grooves 182 in a side surface.

The washer 19 defines a non-circular through hole 191 in a center portion corresponding to the shape of the cross-section of the rotatable shaft 11.

The fastening member 101 may be a nut to engage with the threaded portion 112 of the rotatable shaft 11.

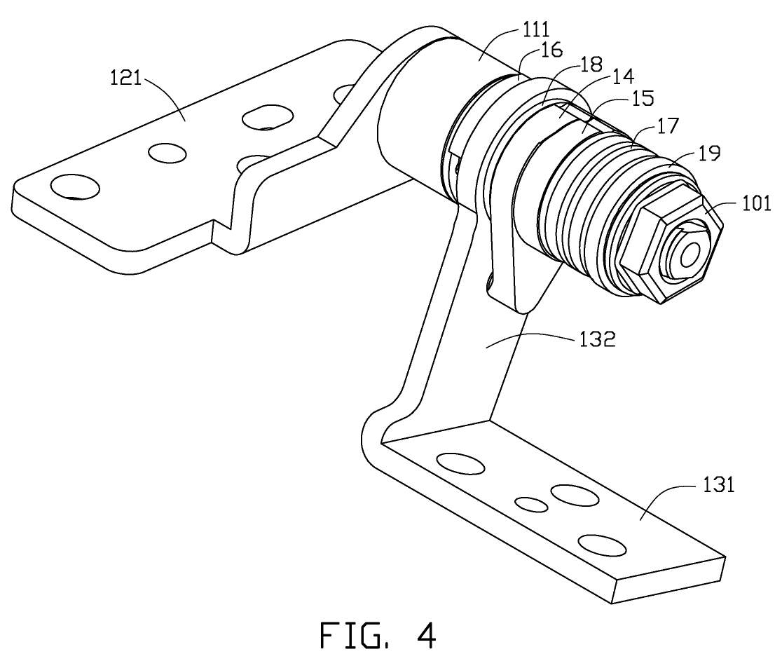

Referring also to FIG. 4, the rotatable shaft 11 is passed through one friction member 18, the non-circular through hole 161 of the restricting member 16, the pivot hole 1321 of the fixed stand 13, the other friction member 18, the cam hole 141 of the cam 14, the through hole 151 of the cam follower 15, the elastic member 17, the washer 19, and engaged with the fastening member 101. The fixing pole 142 of the cam 14 is inserted into the assembling hole 1322 of the fixed stand 13. The positioning protrusions 143 of the cam 14 engage in the corresponding positioning grooves 152 of the cam follower 15. The shaft head 113 engages in the pivot hole 1221 of the rotatable stand 12. Therefore, the rotatable stand 12, the cam follower 15, the restricting member 16, and the washer 19 are non-rotatably connected to the rotatable shaft 11. The fixed stand 13 and the cam 14 are rotatably connected to the rotatable shaft 11.

When the hinge assembly 10 is applied in an electronic device (not shown), the rotatable stand 12 and the fixed stand 13 are fixed on a display cover and a main body of the electronic device, respectively. When opening the electronic device, the rotatable stand 12 rotates with the rotatable shaft 11, for example, in a clockwise direction, thus driving the cam follower 15 to rotate. The positioning protrusions 143 of the cam 14 slide out from the positioning grooves 152 of the cam follower 15. The elastic member 17 becomes compressed and provides an elastic force along the rotatable shaft 11, thus enabling the components of the hinge assembly 10 to contact each other tightly. When the display cover reaches a desired angle, the desired angle of the display cover relative to the main body can be retained via the frictional forces generated between the components of the hinge assembly 10. The first and second limiting surfaces 1621, 1622 of the restricting member 16 are configured to block the limiting protrusion 1323 of the fixed stand 13, thus defining a rotatable range of the rotatable stand 12.

When closing the electronic device, the rotatable stand 12 rotates with the rotatable shaft 11, for example, in a counterclockwise direction, thus driving the cam follower 15 to rotate. The positioning protrusions 143 of the cam 14 are close to the positioning grooves 152 of the cam follower 15. After the display cover is manually rotated to a certain position, the elastic force provided by the elastic member 17 drives the positioning protrusions 143 of the cam 14 to engage in the positioning grooves 152 of the cam follower 15, thus driving the display cover to close on the main body automatically.

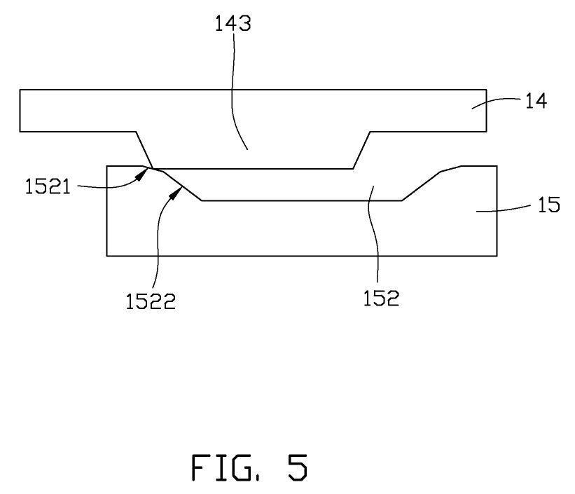

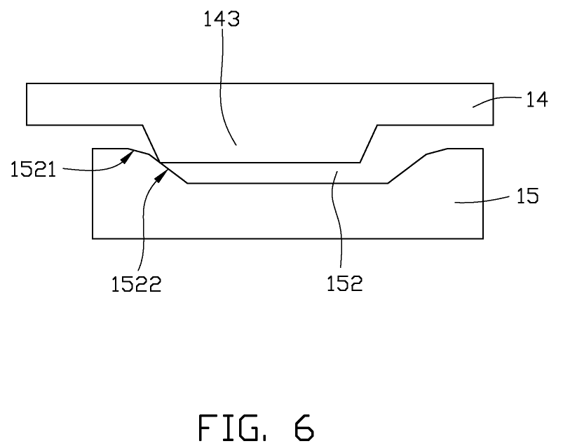

Referring to FIGS. 5 and 6, the positioning protrusion 143 engages with the first slanted surface 1521 of the positioning groove 152, causing the display cover to close slowly due to the small gradient of the first slanted surface 1521, until the positioning protrusion 143 engages with the second slanted surface 1522 of the positioning groove 152. The display cover then closes quickly due to the large gradient of the second slanted surface 1522, until the display cover folds on the main body.

Since the first slanted surface 1521 has a buffering effect to prevent the display cover from closing quickly from a large angle, the shock or impact of the display cover is minimized or avoided. In addition, the second slanted surface 1522 facilitates the display cover to close quickly at the moment of closure. This quick closure does not impart shock or cause impact to the display cover, because the angle between the display cover and the main body allowing the display cover to close quickly is very small. Moreover, the positioning protrusions 143 are stably engaged in the positioning grooves 152 due to the large gradient of the second slanted surface 1522, so that the display cover is stably closed on the main body.

The angle between the display cover and the main body during the beginning of the automatic closure depends on the lengths of the first and second slanted surface 1521, 1522. For example, when the angle between the display cover and the main body is about 10 degrees, the display cover begins to close slowly. When the angle between the display cover and the main body is about 2 degrees, the display cover begins to close quickly.

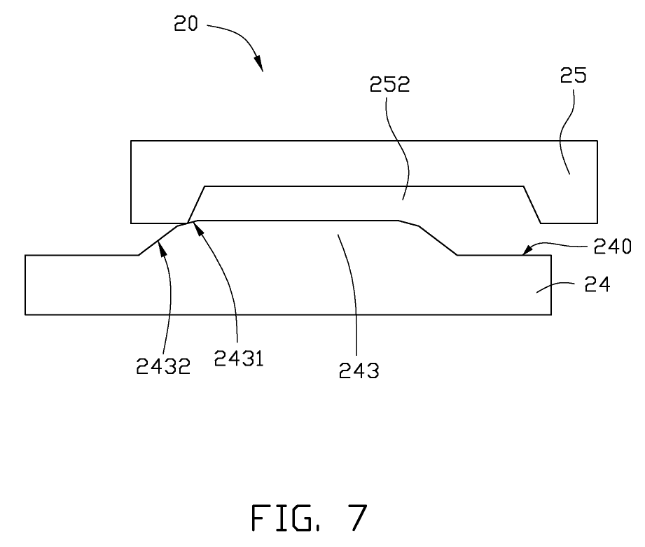

Referring to FIG. 7, a second embodiment of a hinge assembly 20 is similar in principle to the first embodiment of the hinge assembly 10, except that the cam 24 forms two positioning protrusions 243 in a side surface 240. Each positioning protrusion 243 has two side walls, each side wall includes a first slanted surface 2431 and a second slanted surface 2432 connected to each other. The first slanted surface 2431 is adjacent to a top surface of the positioning protrusion 243. The second slanted surface 2432 is adjacent to the side surface 240. A gradient of the first slanted surface 2431 relative to the top surface of the positioning protrusion 243 is smaller than that of the second slanted surface 2432 relative to the top surface of the positioning protrusion 243. The cam follower 25 defines two positioning grooves 252 corresponding to the positioning protrusions 243, and two side walls of each positioning groove 252 are slanted surfaces.

During the automatic closure of the display cover, the first slanted surface 2431 of the positioning protrusion 243 engages in the positioning groove 252, causing the display cover to close slowly due to the small gradient of the first slanted surface 2431, until the second slanted surface 2432 of the positioning protrusion 243 engages in the positioning groove 252. The display cover then closes quickly due to the large gradient of the second slanted surface 2432, until the display cover folds on the main body.

In alternative embodiments, the positioning protrusions 243 may be formed on the cam follower 25, and the positioning grooves 252 may be defined in the cam 14. In addition, the number of the positioning protrusions 243 and the corresponding number of the positioning grooves 252 may be any desired number, such as one, three, four, five, or more.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A hinge assembly, comprising:
a rotatable shaft;
a rotatable stand non-rotatably connected to the rotatable shaft;
a fixed stand rotatably connected to the rotatable shaft;
a cam rotatably connected to the rotatable shaft, and fixed to the fixed stand;
a cam follower non-rotatably connected to the rotatable shaft; and
an elastic member sleeved on the rotatable shaft to provide an elastic force to drive the cam follower to contact the cam;
wherein one of the cam and the cam follower forms a positioning protrusion thereon, the other of the cam and the cam follower defines a positioning groove therein to engage with the positioning protrusion; the positioning groove has a side wall comprising a first slanted surface and a second slanted surface connected to each other; the second slanted surface is adjacent to a bottom surface of the positioning groove; a gradient of the first slanted surface relative to the bottom surface of the positioning groove is smaller than that of the second slanted surface relative to the bottom surface of the positioning groove.

2. The hinge assembly of claim 1, wherein the positioning protrusion has a side wall, the side wall is a slanted surface.

3. The hinge assembly of claim 2, wherein the positioning groove is defined in a side surface of the cam follower, the first slanted surface of the positioning groove is adjacent to the side surface of the cam follower; the positioning protrusion is formed on a side surface of the cam.

4. The hinge assembly of claim 1, further comprising a restricting member sleeved on the rotatable shaft; the restricting member forms a first limiting surface and a second limiting surface; the fixed stand forms a limiting protrusion to abut the first and second limiting surfaces respectively.

5. The hinge assembly of claim 1, wherein a fixing pole is formed on the cam; the fixed stand defines an assembling hole; the fixing pole is fixedly received in the assembling hole of the fixed stand.

6. The hinge assembly of claim 1, wherein a cross-section of the rotatable shaft perpendicular to a rotating axis thereof is double-D shaped; the fixed stand defines a circular pivot hole; the cam defines a circular cam hole; the cam follower defines a non-circular through hole corresponding to the shape of the cross-section of the rotatable shaft; the rotatable shaft is inserted through the circular pivot hole of the fixed stand, the circular cam hole of the cam and the non-circular through hole of the cam follower.

7. The hinge assembly of claim 1, wherein the rotatable shaft has a shaft head; the rotatable stand defines a non-circular pivot hole corresponding to the shape of the shaft head; the shaft head is fixedly inserted in the non-circular pivot hole of the rotatable stand.

8. The hinge assembly of claim 1, wherein a threaded portion is formed at an end of the rotatable shaft; the hinge assembly further comprises a fastening member to engage with the threaded portion.

9. The hinge assembly of claim 1, wherein the elastic member comprises a plurality of spring washers.

10. The hinge assembly of claim 1, further comprising a friction member sleeved on the rotatable shaft, and positioned adjacent to the fixed stand.

11. The hinge assembly of claim 10, wherein at least one of the friction member, the cam, and the cam follower defines a plurality of lubricant grooves.

12. A hinge assembly, comprising:
a rotatable shaft;
a rotatable stand non-rotatably connected to the rotatable shaft;
a fixed stand rotatably connected to the rotatable shaft;
a cam rotatably connected to the rotatable shaft, and fixed to the fixed stand;
a cam follower non-rotatably connected to the rotatable shaft; and
an elastic member sleeved on the rotatable shaft to provide an elastic force to drive the cam follower to contact the cam;
wherein one of the cam and the cam follower forms a positioning protrusion thereon, the other of the cam and the cam follower defines a positioning groove therein to engage with the positioning protrusion; the positioning protrusion has a side wall comprising a first slanted surface and a second slanted surface connected to each other; the first slanted surface is adjacent to a top surface of the positioning protrusion; a gradient of the first slanted surface relative to the top surface of the positioning protrusion is smaller than that of the second slanted surface relative to the top surface of the positioning protrusion.

13. The hinge assembly of claim 12, wherein the positioning groove has a side wall, the side wall is a slanted surface.

14. The hinge assembly of claim 13, wherein the positioning protrusion is formed on a side surface of the cam, the second slanted surface of the positioning protrusion is adjacent to the side surface of the cam; the positioning groove is defined in a side surface of the cam follower.

15. The hinge assembly of claim 12, further comprising a restricting member sleeved on the rotatable shaft, the restricting member forms a first limiting surface and a second limiting surface; the fixed stand forms a limiting protrusion to abut the first and second limiting surfaces respectively.

16. The hinge assembly of claim 12, wherein a fixing pole is formed on the cam; the fixed stand defines an assembling hole; the fixing pole is fixedly received in the assembling hole of the fixed stand.

17. The hinge assembly of claim 12, wherein a cross-section of the rotatable shaft perpendicular to a central axis thereof is double-D shaped; the fixed stand defines a circular pivot hole therein; the cam defines a circular cam hole; the cam follower defines a non-circular through hole corresponding to the shape of the cross-section of the rotatable shaft; the rotatable shaft is inserted through the circular pivot hole of the fixed stand, the circular cam hole of the cam and the non-circular through hole of the cam follower.

18. The hinge assembly of claim 12, wherein the rotatable shaft has a shaft head; the rotatable stand defines a non-circular pivot hole corresponding to the shape of the shaft head; the shaft head is fixedly inserted in the non-circular pivot hole of the rotatable stand.

19. The hinge assembly of claim 12, wherein a threaded portion is formed at an end of the rotatable shaft; the hinge assembly further comprises a fastening member to engage with the threaded portion.

20. The hinge assembly of claim 12, further comprising a friction member sleeved on the rotatable shaft, and positioned adjacent to the fixed stand.
